(19) United States
(12) Patent Application Publication
(10) Pub. No.: US 2026/0256316 A1
(43) Pub. Date: Sep. 3, 2026

(54) SKEWER ASSEMBLY AND METHOD OF USE

(71) Applicant: Scorpion Designs Corporation, Unity (CA)

(72) Inventors: Amanda Doreen BOSER, Unity (CA); Joseph Perry BOSER, Unity (CA); Bartek ZALEWSKI, Newmarket (CA)

(73) Assignee: Scorpion Designs Corporation, Unity, SK (CA)

(21) Appl. No.: 19/549,213

(22) Filed: Feb. 25, 2026

Related U.S. Application Data
(60) Provisional application No. 63/764,754, filed on Feb. 28, 2025.
(60) Provisional application No. 63/765,049, filed on Feb. 28, 2025.

(51) Int. Cl. A47J 37/04; H02K 7/00

(52) U.S. Cl. CPC A47J 37/041; H02K 7/003

(57) ABSTRACT

A skewer including a motor assembly. The skewer includes a fork selectively engagable with the motor assembly. The skewer further includes a housing configured to receive and hold the motor assembly. The fork is selectively rotatable via the motor assembly. The motor assembly includes a battery and a motor configured to selectively receive power from the battery. The motor assembly further includes a coupling engaged with the motor. The coupling is selectively rotatable via the motor. A method of using the skewer, includes selectively engaging a fork with a housing of the skewer. The method further includes receiving a food product on the fork and placing the food product at least partially over a heat source. The method further include rotating the fork via a motor assembly without moving a user's hand.

### REFERENCE TO RELATED APPLICATIONS

This application claims the benefit of U.S. Provisional Application Ser. No. 63/764,754, filed on Feb. 28, 2025 and U.S. Provisional Application Ser. No. 63/765,049, filed on Feb. 28, 2025; the disclosures of which are incorporated herein by reference.

### TECHNICAL FIELD

This disclosure is directed to a skewer assembly. More particularly, the disclosure is directed to the skewer assembly that is selectively rotatable.

### BACKGROUND ART

People enjoy cooking and consuming food products that are cooked over an open flame or are roasted for a variety of reasons. These methods of cooking give the food enhanced flavor and the cooking method can be a fun social experience. To assist in their cooking efforts, many people user skewer to hold or secure their food products during the cooking process.

Skewer are a long, thin pointed object for holding or securing food products thereto. Skewers are commonly used in grilling or roasting good products such as meat, fish, vegetables, or desserts. The food products are threaded onto the skewer and cooked over an open flame or in an over. The use of a skewer is helpful to ensure even cooking and can create a delicious charred exterior.

Nevertheless, skewers do not ensure that the food products are cooked well or evenly. Cooking over an open flame can be challenging due to the uneven heat distribution and the variability of the flame itself. Due to the nature of open flame cooking the user must constantly monitor the food products to prevent them from burning or undercooking.

### SUMMARY OF THE INVENTION

A skewer assembly with a motor assembly which can be adjusted to rotate a fork of the skewer assembly relative to the housing to assist in a user obtaining even cooking of a food product located on the fork.

In one aspect, an exemplary embodiment of the present disclosure may provide skewer including a motor assembly; a fork selectively engagable with the motor assembly; a housing configured to receive and hold the motor assembly; and wherein the fork is selectively rotatable via the motor assembly.

In another aspect, an exemplary embodiment of the present disclosure may provide wherein the motor assembly includes a battery; a motor configured to selectively receive power from the battery; a coupling engaged with the motor; and wherein the coupling is selectively rotatable via the motor. In another aspect, an exemplary embodiment of the present disclosure may provide wherein the coupling includes a projection configured to secure a portion of the fork therein; a first portion configured to receive a portion of the fork therein; and a second portion configured to receive a shaft of the motor. In another aspect, an exemplary embodiment of the present disclosure may provide wherein the projection includes an inner surface and an outer surface spaced apart from one another; and a first passage defined by the inner surface. In another aspect, an exemplary embodiment of the present disclosure may provide wherein the projection includes a lip at a front of the coupling; an edge extending between the lip and the first portion; a pair of slots extending through the lip and edge; and a split ring received at the edge. In another aspect, an exemplary embodiment of the present disclosure may provide wherein the first portion includes an inner surface and an outer surface spaced apart from one another; a second passage defined by the inner surface; and a pair of inset extending through a portion of the first portion. In another aspect, an exemplary embodiment of the present disclosure may provide wherein the first passage and the second passage are in fluid communication with one another. In another aspect, an exemplary embodiment of the present disclosure may provide wherein the pair of slots and the pair of insets are aligned with one another and in fluid communication with one another. In another aspect, an exemplary embodiment of the present disclosure may provide wherein the fork further includes a set of bumps extending radially outwardly from a rod proximate a rear; wherein when the fork is received within the coupling, the set of bumps are received within the pair of insets; and wherein when the fork is received within the coupling, the rod is received within the second passage. In another aspect, an exemplary embodiment of the present disclosure may provide wherein in an installed position, the split ring is configured to present the fork from disengaging with the coupling. In another aspect, an exemplary embodiment of the present disclosure may provide wherein the second portion includes an inner surface and an outer surface spaced apart from one another; an aperture defined by the inner surface; and wherein the shaft of the motor is received within the aperture. In another aspect, an exemplary embodiment of the present disclosure may provide wherein the second portion further includes a hole extending radially from the inner surface to the outer surface; and wherein a securement device is at least partially received within the hole to hold and secure the shaft of the motor within the aperture.

In one aspect, an exemplary embodiment of the present disclosure may provide a method of using a skewer, including selectively engaging a fork with a housing of the skewer; receiving a food product on the fork; placing the food product at least partially over a heat source; and rotating the fork via a motor assembly without moving a user's hand.

In another aspect, an exemplary embodiment of the present disclosure may provide engaging a button; and activating a motor assembly to rotate the fork. In another aspect, an exemplary embodiment of the present disclosure may provide engaging the fork with the motor assembly and thereby securing the fork to the housing. In another aspect, an exemplary embodiment of the present disclosure may provide wherein engaging the fork to the motor assembly further includes receiving at least a portion of the fork within a coupling. In another aspect, an exemplary embodiment of the present disclosure may provide inserting a rod of the fork into a projection and a first portion of the coupling; engaging a set of bumps extending radially outwardly from a rod of the fork with a projection of the coupling; inserting the set of bumps into a pair of slots defined by the projection; and enlarging a split ring received around the projection. In another aspect, an exemplary embodiment of the present disclosure may provide continuing to insert the rod into the first portion of the coupling; inserting the set of bumps into a pair of insets defined by the first portion; and receiving at least a portion of the rod within a passage defined by the first portion. In another aspect, an exemplary embodiment of the present disclosure may provide wherein powering the motor of the motor assembly further includes engaging a control to transmit a signal to a circuit board; and drawing power by the circuit board from a battery. In another aspect, an exemplary embodiment of the present disclosure may provide wherein the battery is replaceable by removing a cover; removing a spent battery from a battery holder; inserting a new battery into the battery holder; and replacing the cover.

In one aspect, an exemplary embodiment of the present disclosure may provide a skewer assembly comprising a motor assembly, a fork selectively engagable with the motor assembly, and a housing configured to receive and hold the motor assembly. The fork is selectively rotatable via the motor assembly.

In another aspect, an exemplary embodiment of the present disclosure may provide where the motor assembly comprises a motor configured to selectively receive power from a battery and a coupling engaged with the motor. The coupling is selectively rotatable via the motor. In another aspect, an exemplary embodiment of the present disclosure may provide where the motor assembly further comprises a control configured to transmit the power from the battery to the motor.

In another aspect, and exemplary embodiment of the present disclosure may provide a method of using a skewer assembly, comprising providing a motor assembly within a housing; engaging a fork with the motor assembly and thereby securing the fork to the housing; powering a motor of the motor assembly; rotating a coupling engaged with the motor; and rotating the fork held within the coupling.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is front, right, top isometric view of a skewer assembly in accordance with the present disclosure.

FIG. 2 is an exploded view of the skewer assembly.

FIG. 3 is a top plan view of the skewer assembly.

FIG. 4 is right side elevation view of the skewer assembly.

FIG. 5 is a front end elevation view of the skewer assembly.

FIG. 6 is an enlarged top plan view of a housing of the skewer assembly with a cover removed.

FIG. 7 is an enlarged left side elevation view of the housing of the skewer assembly with the battery cover removed.

FIG. 8 is a partial cross-sectional view of the skewer assembly with a fork removed taken along line 8-8 in FIG. 5.

FIG. 8A is an enlarged view of the highlighted region in FIG. 8.

FIG. 9A is an enlarged right side elevation view of a coupling of the skewer assembly.

FIG. 9B is an enlarged front elevation view of the coupling.

FIG. 9C is a cross-sectional view of the coupling taken along line 9C-9C in FIG. 9B

FIG. 10A is a cross-sectional view of the coupling shown in

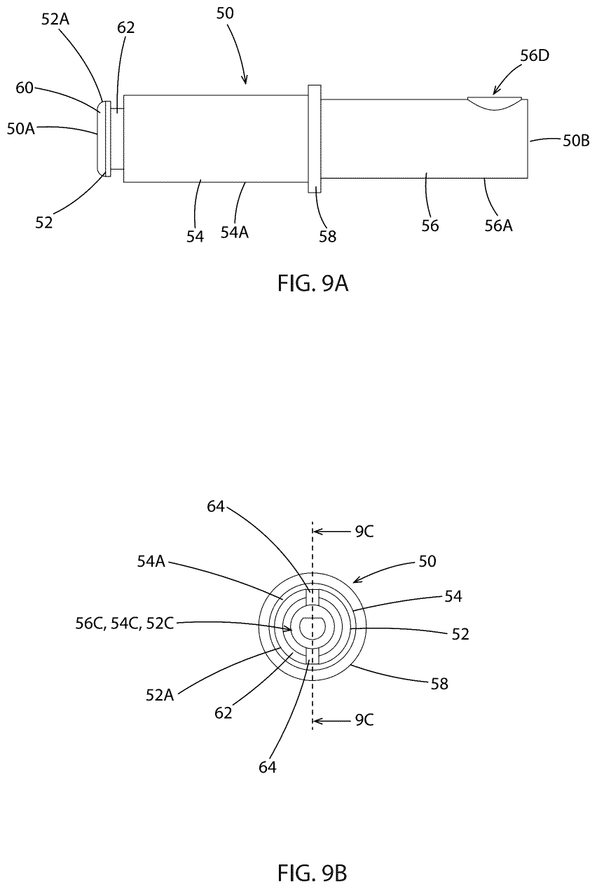

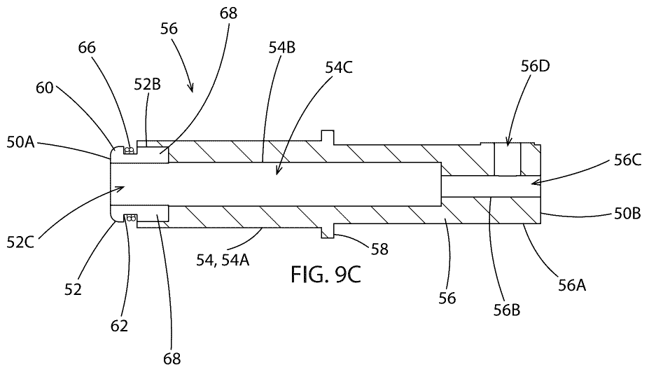

FIG. 9B shown in a first operational position with the fork of the skewer assembly being engaged with the coupling.

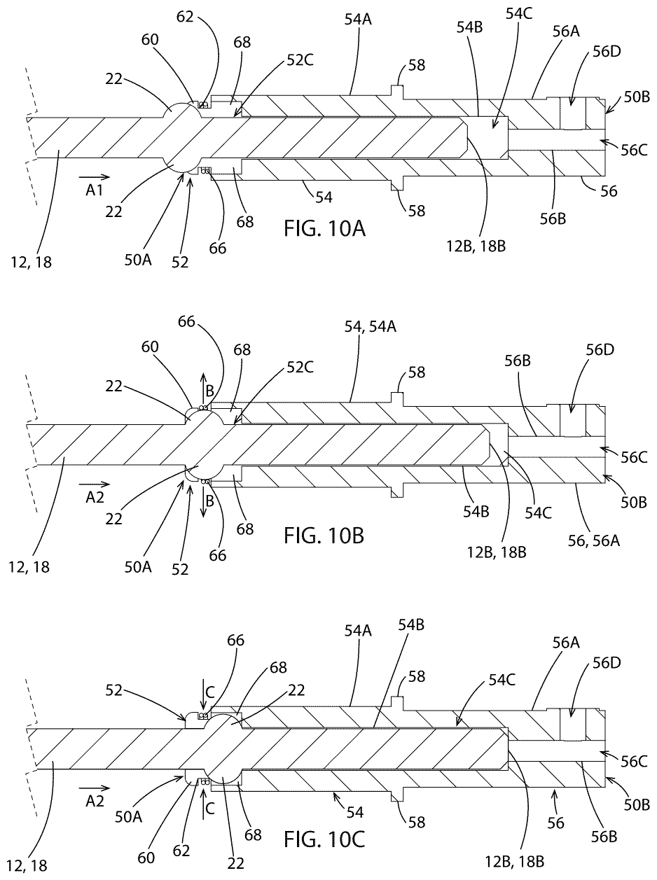

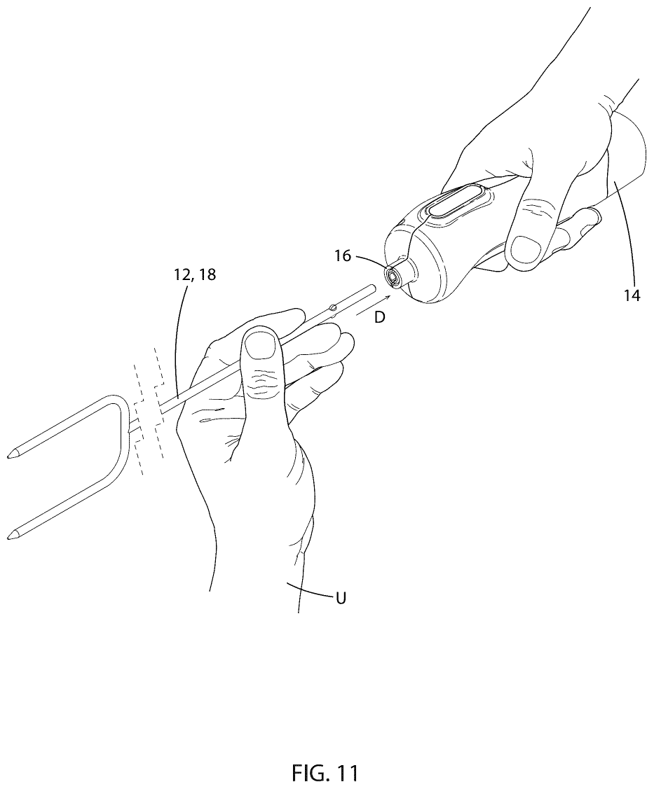

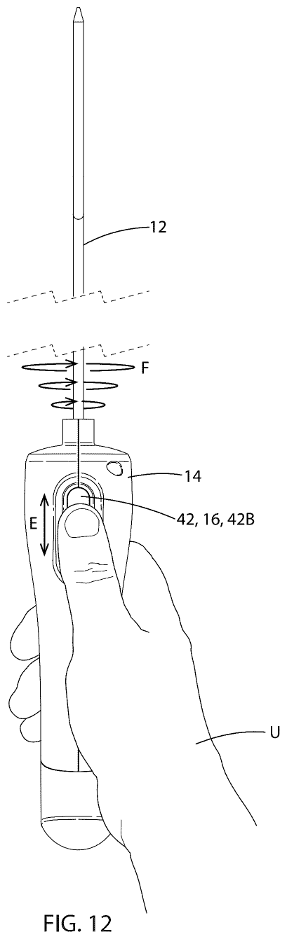

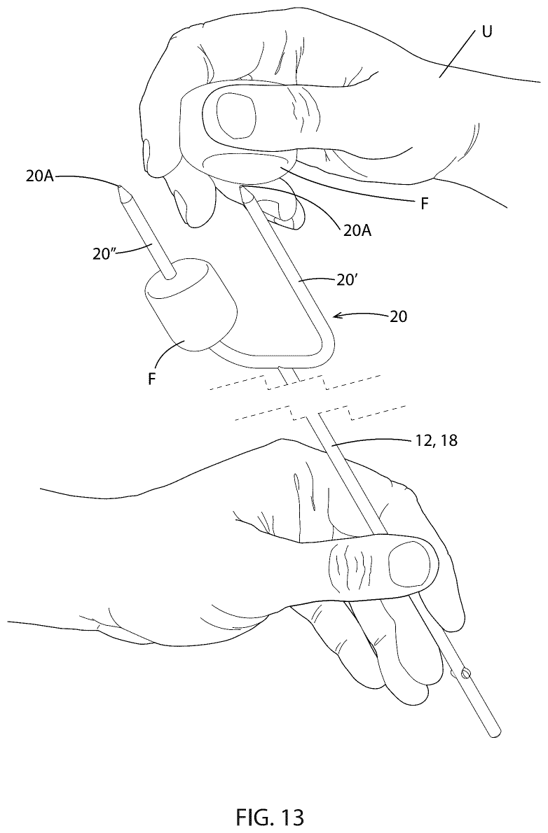

FIG. 10B is cross-sectional view of the coupling shown in

FIG. 9B shown in a second operational position with the fork of the skewer assembly being engaged with the coupling.

FIG. 10C cross-sectional view of the coupling shown in FIG. 9B shown in a third operational position with the fork of the skewer assembly being engaged with the coupling.

FIG. 11 is an operational view of the fork being engaged with the housing of the skewer assembly by a user.

FIG. 12 is an operational view of the user engaging a motor assembly to rotate the fork of the skewer assembly relative to the housing of the skewer assembly.

FIG. 13 is an operational view of the user placing a food product onto the fork.

Similar numbers refer to similar parts throughout the drawings.

### DETAILED DESCRIPTION

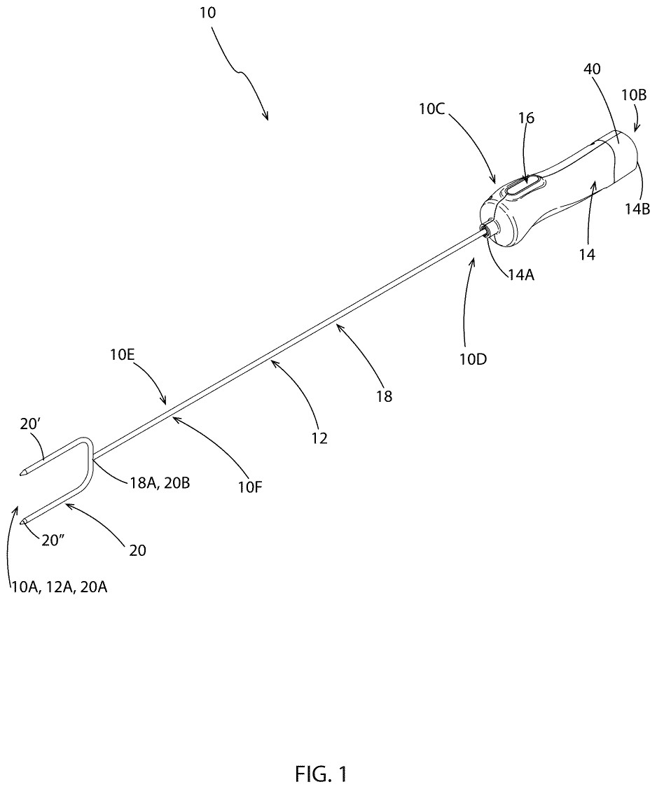

FIG. 1 shows a skewer assembly, generally indicated at 10 in accordance with the present disclosure. Skewer assembly 10 includes a front end 10A and a rear end 10B opposite one another and defining the frontmost and rearmost limit of skewer assembly 10, respectively. Skewer assembly 10 further includes a top 10C and a bottom 10D opposite one another and a first side 10E and a second side 10F opposite one another.

Referring still to FIG. 1, skewer assembly 10 includes a fork 12 and a housing 14. Housing 14 receives at least a portion of the fork 12. Skewer assembly 10 further includes a motor assembly 16 located within housing 14. Fork 12 is configured to be at least partially received within a part of the motor assembly 16.

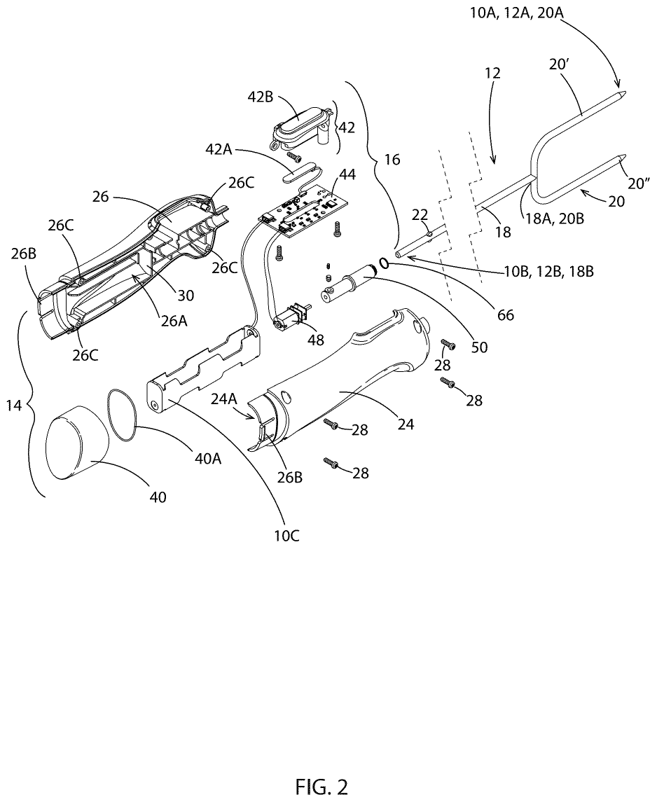

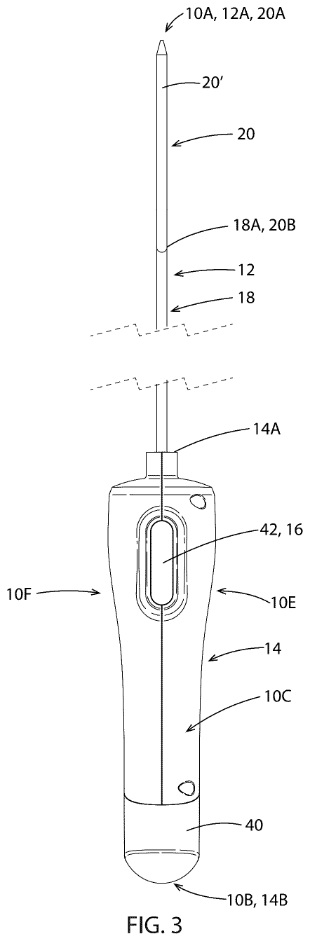

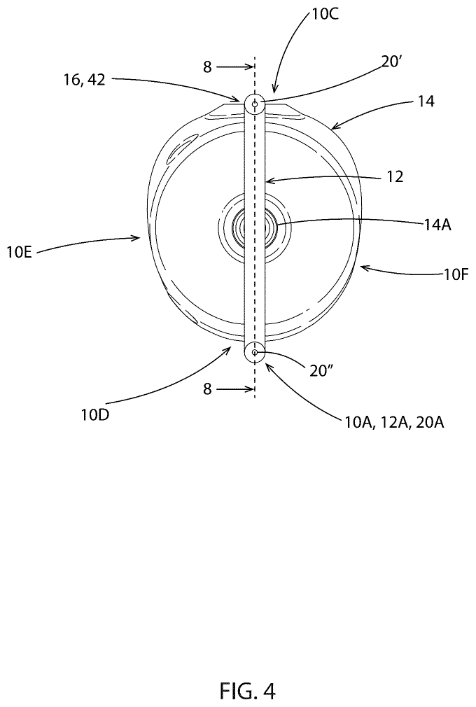

It will be understood that fork 12 may be of any length as indicated by the breaklines shown in FIGS. 2-4.

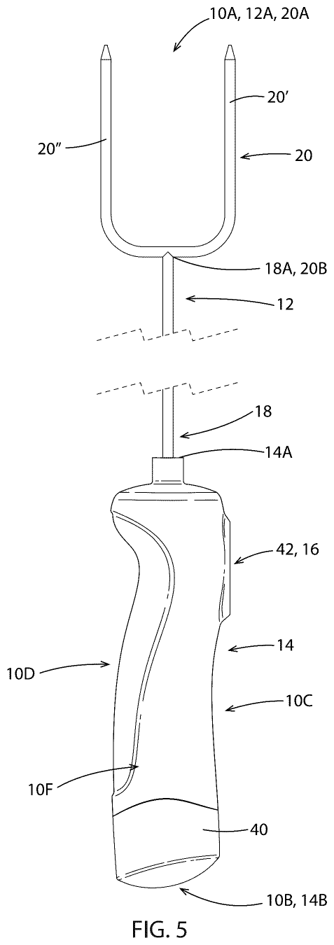

Referring now to FIGS. 1-5, fork 12 generally includes a tip or front 12A and a rear 12B. Fork 12 generally includes a rod 18 and a tine or prong 20 which are continuous with one another. Prong 20 extends inwardly from front 12A of fork 12 and rod 18 extends between prong 20 and rear 12B of fork 12.

Rod 18 includes a front 18A and a rear 18B opposite one another. Rear 18B is continuous with front 12A of fork 12. Rod 18 is configured to be at least partially receivable within the housing 14 at rear 18B.

Rod 18 further includes a set of bumps 22 (see FIGS. 10A-10C) extending radially outwardly from the rod 18 proximate the rear 18B. The set of bumps 22 will be described in more detail below regarding the use of skewer assembly 10.

Prong 20 includes a front 20A and a rear 20B opposite one another where the rear 18B is continuous with the front 18A of rod 18. Front 18A is contiguous with front 12A of fork 12 and front 10A of skewer assembly 10.

In one specific embodiment, prong 20 is generally U-shaped and includes a first prong 20′ and a second prong 20″ which both are adapted to receive a food product hereon as is illustrated in FIG. 12. In one specific embodiment, the front 20A each the first prong 20′ and the second prong 20″ are pointed.

It will be understood that in alternative embodiments, fork 12 may of any shape or configuration to be at least partially receivable within the housing 14 and be adapted to receive at least a portion of an object thereon. For example, instead of two prongs, there maybe three, four, or more tines or prongs on the fork 12.

Referring now to FIGS. 1-8A, housing 14 generally includes a front 14A and a rear 14B opposite one another. Housing 14 includes a first housing 24 and a second housing 26. First housing 24 and second housing 26 are complementary to one another and secured to one another via a plurality of fasteners 28. In one embodiment, an interior 24A of first housing 24 and an interior 26A (FIG. 2) of second housing 26 are identical to one another, however differing configurations are possible. When the interior configurations of the housings 24, 26 are the same, it will be understood that the following description of interior 26A of first housing 24 equally applies to interior 26A of second housing 26 unless explicitly stated otherwise. Interior 26A includes a plurality of walls and recesses 30.

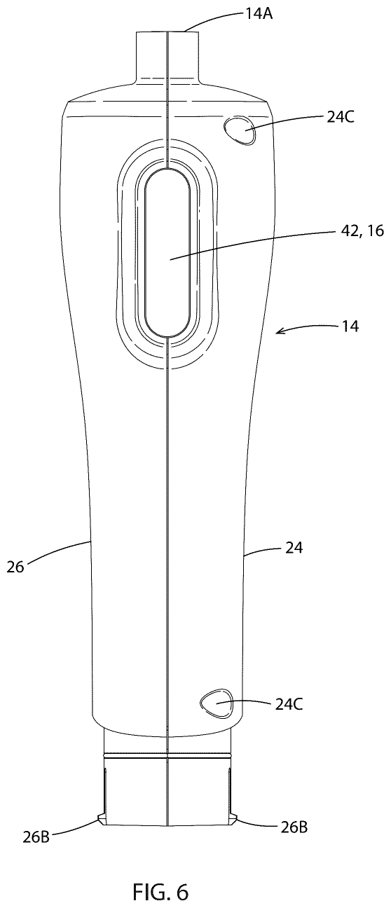

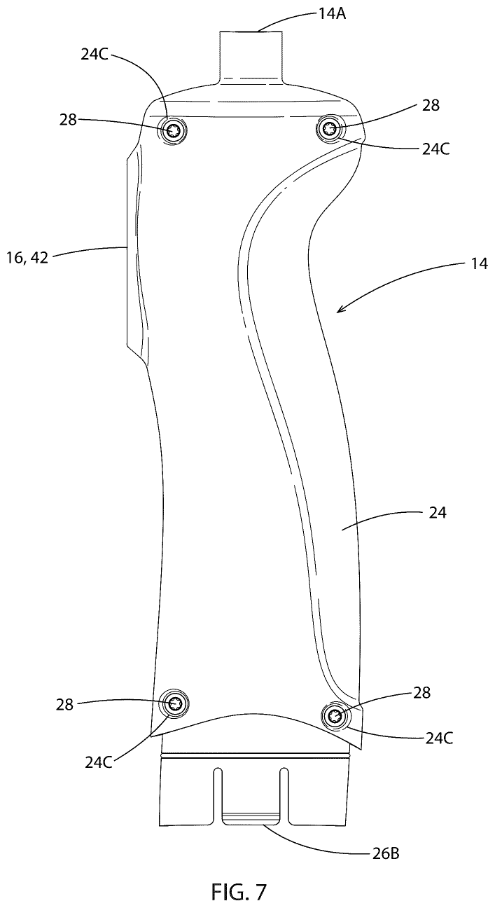

Second housing 26 may define a tab 26B (see FIGS. 6 and 7) extending outwardly from an outer surface of the second housing 26 at the rear 14B of housing 14.

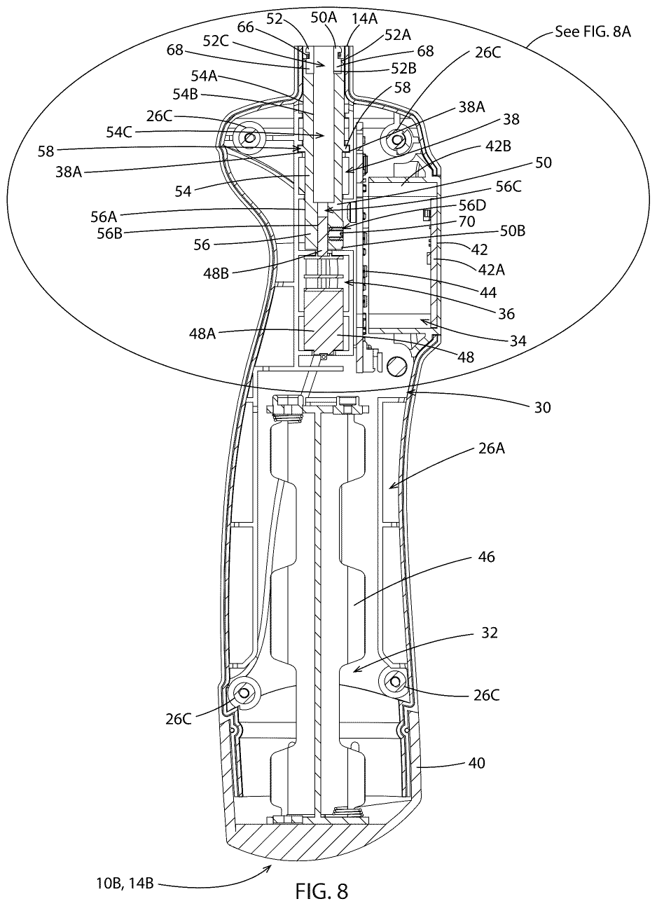

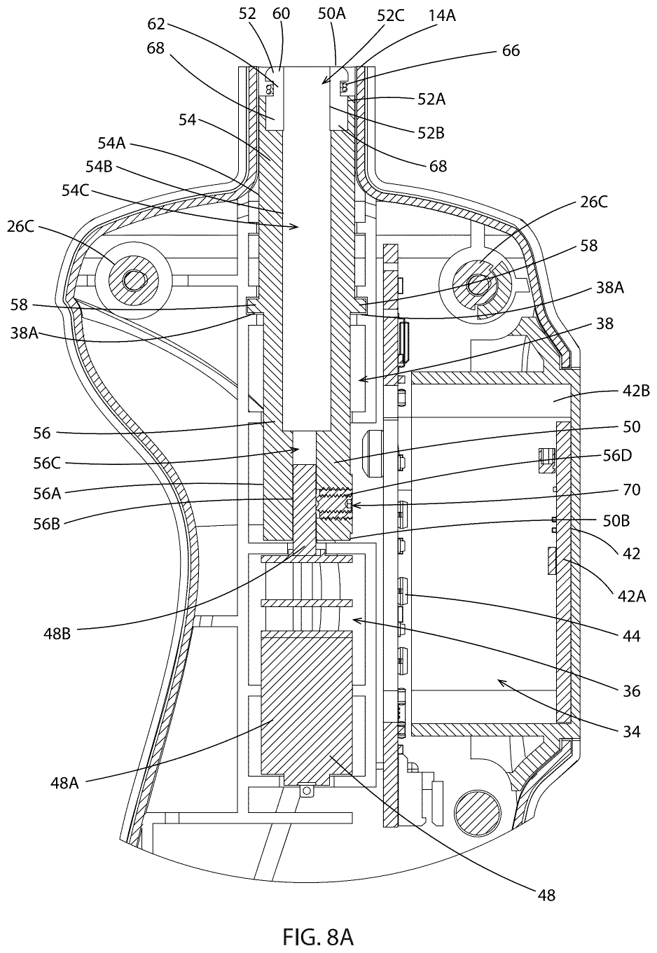

Referring now to FIGS. 8 and 8A, interior 26A and the plurality of walls and recesses 30 together define a first chamber 32 which is configured to receive a portion of the motor assembly 16. Interior 26A and the plurality of walls and recesses 30 together further define a second chamber 34 which is configured to receive another portion of the motor assembly 16. Interior 26A and the plurality of walls and recesses 30 together further define a third chamber 36 which is configured to receive another portion of the motor assembly 16. Interior 26A and the plurality of walls and recesses 30 together further define a fourth chamber 38 which is configured to receive yet another portion of the motor assembly 16 and at least a portion of the fork 12.

First chamber 32, second chamber 34, third chamber 36 and fourth chamber 38 will be discussed in more detail below regarding the motor assembly 16.

It will be understood that the interior 26A and the plurality of walls and recesses 30 may be of any size, shape, configuration, or define any number of chambers to receive and hold any number of portions of the motor assembly 16 and at least the portion of the fork 12.

In one specific embodiment, first housing 24 may define a plurality of holes 24C (see FIGS. 6 and 7) extending through the first housing 24 and the second housing 26 may include a plurality of anchors 26C (see FIGS. 2 and 8) complementary to the plurality of holes 24C. The plurality of fasteners 28 are configured to be received within the plurality of holes 24C and secured to the plurality of anchors 26C to secure the first housing 24 and the second housing 26 to one another.

Referring now to FIGS. 1-5 and 8, housing 14 further includes a cover 40 which is configured to encapsulate outer surfaces of the first and second housings 24, 26 at the rear 14B of housing 14. Cover 40 is configured to allow for selective access to the first chamber 32 (FIG. 6).

In one specific embodiment, cover 40 may include an o-ring 40A (see FIG. 2) which is configured to assist in the encapsulation of the outer surfaces of the first and second housings 24, 26 at the rear 14B of housing 14.

Referring now to FIGS. 2 and 8-8A, motor assembly 16 generally includes a control 42, circuit board 44, a battery holder 46, a motor 48, and a coupling 50.

Control 42 generally includes a button 42A and a holder 42B which is configured to receive and hold the button 42A. Button 42A is configured to engage with and control the circuit board 44. Control 42 will be discussed in more detail below regarding the method of using skewer assembly 10. In one specific embodiment, button 42A is a capacitive touch button.

Referring still to FIGS. 2 and 8-8A, circuit board 44 is generally an electronic circuit board which is controlled by the control 42 and is configured to receive power from a battery (not shown) received within the battery holder 46, the battery (not shown) can be replaced. Circuit board 44 is further configured to communicate with motor 48 to supply the motor 48 with power from the battery (not shown). In one specific embodiment, circuit board 44 is a printed circuit board.

Referring to FIG. 8, battery holder 46 is configured to be received within the first chamber 32 defined by the housing 14 and the battery holder is secured in its place by the plurality of walls and recesses 30.

Referring to FIGS. 8 and 8A, control 42 and circuit board 44 are configured to be received within the second chamber 34 defined by the housing 14. The control 42 and circuit board 44 are secured in their places by the plurality of walls and recesses 30.

Motor 48 generally includes a gear box 48A and a shaft 48B extending outwardly from the gear box 48A. Shaft 48B is selectively rotatable relative to the gear box 48A. The power supplied from the battery (not shown) to the motor 48 via the circuit board 44 is used to rotate the shaft 48B relative to the gear box 48A. In one specific embodiment, motor 48 is a speed reduction gear motor. In another specific embodiment, motor 48 is a DC6V 30 RPM reduction gear motor D type N20 motor. Motor 48 is configured to be received within the third chamber 36 defined by the housing 14 and motor 48 is secured in its placed by the plurality of walls and recesses 30. It will be understood that any motor or another similar piece of equipment suitable to provide a shaft or similar object that is rotatable may be used in place of motor 48.

Referring now to FIGS. 8-9C, coupling 50 generally includes a front 50A and a rear 50B opposite one another. Coupling 50 includes a projection 52, first portion 54, a second portion 56 which are integral with one another. Coupling 50 further includes an annular flange 58 extending outwardly from an outer surface (not numbered) of the coupling 50. Annular flange 58 will be discussed in more detail herein in relation to the housing 14.

Projection 52 extends inwardly from the front 50A of coupling 50 and the second portion 56 extends inwardly from the rear 50B of the coupling 50. First portion 54 extends between the projection 52 and the second portion 56. Projection 52 includes an inner surface 52A and an outer surface 52B spaced apart from one another. Inner surface 52A defines a first passage 52C.

Referring to FIGS. 9A-9C, projection 52 is generally made of up a lip 60 located at the front 50A of the coupling 50 and a neck or edge 62 extending between the lip 60 and the first portion 54 of the coupling 50. Projection 52 defines a pair of slots 64 (FIG. 9B) extending through the lip 60 and edge 62. The neck or edge 62 has a smaller diameter than lip 60. The projection 52 is configured to receive a split ring 66 at the edge 62. Split ring 66 and the pair of slots 64 will be described in more detail below regarding the use of skewer assembly 10.

Referring now to FIGS. 8-9C, first portion 54 includes an inner surface 54A and an outer surface 54B spaced apart from one another. Inner surface 52A defines a second passage 54C. First portion 54 further defines the pair of insets 68 which extend through a portion of the first portion 54.

First passage 52C and second passage 54C are in fluid or open communication with one another. Pair of insets 68 and pair of slots 64 are substantially aligned with one another and are in fluid or open communication with one another. First passage 52C, second passage 54C, pair of slots 64, and pair of insets 68 are in fluid or open communication with one another and are configured to allow rod 18 to be at least partially received within the coupling 50.

Referring still to FIGS. 8-9C, second portion 56 includes an inner surface 56A and an outer surface 46B spaced apart from one another. Inner surface 56A defines an aperture 56C. The shaft 48B of the motor 48 is at least partially receivable within aperture 56C of the second portion 56 of the coupling 50. Second portion 56 further defines a hole 56D extending radially from the inner surface 56A to the outer surface 56B of the second portion 56. Hole 56D is configured to receive at least a portion of a securement device 70 (see FIG. 2). Securement device 70 is configured to be inserted into the hole 56D to hold and secure the shaft 48B of the motor 48 within the aperture 56C of the second portion 56 of the coupling 50.

Coupling 50 is configured to be configured to be received within the fourth chamber 38 defined by the housing 14 and the coupling 50 is secured in its place by plurality of walls and recesses 30.

Referring to FIGS. 8 and 8A, fourth chamber 38 further defines a set of insets 38A within the plurality of walls and recesses 30. Annular flange 58 is configured to be received within the set of insets 38A to prevent the movement of coupling 50 within fourth chamber 38.

Referring now to FIGS. 10A-10C, the rod 18 and coupling 50 are shown in a first operational position, the engagement of the rod 18 with the coupling 50 secures the fork 12 to the housing 14. The rod 18 is inserted into the first passage 52C and the second passage 54C of the coupling 50 by a user pushing the rod 18 in the direction of arrow “A1”. As the rod 18 inserted, the set of bumps 22 located on the rod 18 are inserted into the pair of slots 64 defined by the projection 52 and the first portion 54.

Referring to FIG. 10B, the rod 18 and coupling 50 are shown in a second operational position as the rod 18 is further inserted into the first passage 52C and the second passage 54C of the coupling 50 by the user pushing the rod 18 in the direction of arrow “A2”. As the user pushes on the rod 18, the set of bumps 22 engages the split ring 66. The user may rotate the rod 18 to ensure the set of bumps are received within the pair of slots 64. As the split ring 66 is engaged a diameter of split ring 66 is enlarged as is indicated by arrows “B”.

Referring to FIG. 10C, the rod 18 and the coupling 50 are shown in a third operational position or an installed position, as the rod 18 is even further inserted into the coupling 50 by a user pushing the rod 18 in the direction of arrow “A3”. Rod 18 fills the entirely of the first passage 52C and the second passage 54C of the coupling 50. The set of bumps 22 are received within the pair of insets 68 of the second portion 56, where the pair of inserts 68 are in fluid communication with the pair of slots 64. After the rod 18 is securely inserted into the first passage 52C and the second passage 54C of the coupling 50, the diameter of the split ring 66 reverts back to its original diameter as is indicated by arrow “C”. When the set of bumps 22 are received within the pair of insets 68, the split ring 66 in its original diameter prevents the rod 18 from disengaging with the coupling 50 unless a user applies force to the rod an direction opposite of arrow “A3”.

It will be understood that the first operational position ensures the user has aligned the set of bumps 22 with the pair of slots 64 within the projection 52 of the coupling 50. The second operational position allows the user to engage the set of bumps 22 with the split ring 66 to enable the pressure applied by the user to the rod 18 to overcome the bias of the split ring 66 and enlarge the diameter of the split ring 66. The enlargement of the diameter of the split ring 66 enables the set of bumps 22 and thereby the rod 18 to pass therethrough. The third operational view allows for the set of bumps 22 to be received within the pair of insets 68. Once the set of bumps 22 are received with the pair of insets 68, the pressure is no longer applies to the split ring 66 and allows for the split ring 66 to return to its biased position and return to the original diameter. The bais of the split ring 66 towards its original diameter allows for the rod 18 to be secured into the coupling 50 and prevents the rod 18 from disengaging with the coupling 50 unless a user applies pressure by pulling the rod 18 in a direction opposite to the arrows “A1”, “A2”, and “A3”.

It will be understood that the rod 18 can be removed from the coupling 50 and thereby disengaging the fork 12 from the housing 14 by removing the rod 18 from the coupling 50 in a direction opposite that of arrows “A1”, “A2”, and “A3”. As the rod 18 is removed, the diameter of the split ring 66 is again enlarged to allow for the set of bumps 22 to pass therethrough. Once the rod 18 is removed, the diameter of the split ring 66 returns it its original diameter and the rod 18 and thereby the fork 12 is free of the coupling 50 and thereby the housing 14.

The split ring 66 prevents the rod 18 and thereby the fork 12 from disengaging with the coupling 50 and thereby the housing 14 without a user using force to engage the split ring 66.

Having now described skewer assembly 10, a method of assembling and using skewer assembly 10 will be described herein.

Referring now to FIG. 11, the fork 12 and the motor assembly 16 within the housing 14 of the skewer assembly 10 may be provided. A user “U” may insert the fork 12, specifically the rod 18 into the motor assembly 16 and thereby the housing 14 in the direction of arrow “D”. When the user “U” inserts the fork 12 into motor assembly 16, the process shown in FIGS. 10A-10C and described above will apply.

Referring now to FIGS. 12 and 8, once the fork 12 is inserted into the motor assembly 16 and thereby the housing 14, the user “U” engages the control 42, specifically the button 42A, in the direction of arrow “E”. When the user “U” engages the control 42 a signal is transmitted to the circuit board 44. The circuit board 44 draws power from the battery (not shown) held within the battery holder 46. The power is then transmitted to the motor 48 which engages the gear box 48A to rotate the shaft 48B relative to the gear box. The shaft 48B of the motor 48 is held within the aperture 56C of the second portion 56 of the coupling 50. The rotation of the shaft 48B of the motor 48 thereby rotates the coupling 50. Since the rod 18 of the fork 12 is inserted and secured within the first passage 52C of the projection 52 and the second passage 54C of the first portion 54 of the coupling 50, the fork 12 will rotate in the direction of arrow “F”.

It will be understood that control 42 is configured to allow for multiple signals to be transmitted to the circuit board 44 and thereby allowing the user “U” to move the fork 12 in a number of ways. The user “U” may utilize the control 42 to being or end rotation of the fork 12. The user “U” may also utilize the control 42 to change the speed or the rotation of the fork 12.

Referring to FIG. 13, the user “U” may place a food product “F” onto the prong 20 of the fork 12. It will be understood that user “U” may insert any variety of products on the prong 20 which would need to be continuously rotated. The user “U” may engage the food products “F” with the first prong 20′ or the second prong 20″ at the front 20A, which may be pointed to make placing the food products “F” onto the prong 20 easier. It will also be understood that the user “U” may place the food product “F” onto the prong 20 before or after inserting the fork 12 into the motor assembly 16 and thereby the housing 14.

It will also be understood that the battery (not shown) may be replaced by removing the cover 40 to allow access to the first chamber 32 and the battery holder 46. The user can remove a spent battery (not shown) held within the battery holder 46 and replace or insert a new battery (now shown) into the battery holder 46. The cover 40 may then be replaced onto the housing 14.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the prong 20 being U-shaped, the prong 20 can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

More particularly, the device, assembly, or system of the present disclosure, which may include the logic(s) presented herein, includes the features, components, techniques or processes detailed herein that, as combined, accomplished the desired results detailed herein. These specific elements, configuration or techniques of the device, assembly, or system of the present disclosure, some of which may be included in at least one of the appended claims, accomplish these desired results to overcome the then existing problems in the relevant field of computer processor-based systems. Additionally, the features, components, techniques or processes of the device, assembly, or system of the present disclosure, are an unconventional arrangement of elements or unconventionally perform a method detailed herein that was unavailable without the unconventional arrangement of elements. These exemplary, yet particular, arrangements provide an improvement over existing technologies that have failed to operate in the manner, and with the efficiency that is taught by the device, assembly, or system of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A skewer comprising:
a motor assembly;
a fork selectively engagable with the motor assembly;
a housing configured to receive and hold the motor assembly; and
wherein the fork is selectively rotatable via the motor assembly.

2. The skewer according to claim 1, wherein the motor assembly comprises:
a battery;
a motor configured to selectively receive power from the battery;
a coupling engaged with the motor; and
wherein the coupling is selectively rotatable via the motor.

3. The skewer according to claim 2, wherein the coupling comprises:
a projection configured to secure a portion of the fork therein;
a first portion configured to receive a portion of the fork therein; and
a second portion configured to receive a shaft of the motor.

4. The skewer according to claim 3, wherein the projection comprises:
an inner surface and an outer surface spaced apart from one another; and
a first passage defined by the inner surface.

5. The skewer according to claim 4, wherein the projection comprises:
a lip at a front of the coupling;
an edge extending between the lip and the first portion;
a pair of slots extending through the lip and edge; and
a split ring received at the edge.

6. The skewer according to claim 5, wherein the first portion comprises:
an inner surface and an outer surface spaced apart from one another;
a second passage defined by the inner surface; and
a pair of inset extending through a portion of the first portion.

7. The skewer according to claim 6, wherein the first passage and the second passage are in fluid communication with one another.

8. The skewer according to claim 6, wherein the pair of slots and the pair of insets are aligned with one another and in fluid communication with one another.

9. The skewer according to claim 6, wherein the fork further comprises:
a set of bumps extending radially outwardly from a rod proximate a rear;
wherein when the fork is received within the coupling, the set of bumps are received within the pair of insets; and
wherein when the fork is received within the coupling, the rod is received within the second passage.

10. The skewer according to claim 6, wherein in an installed position, the split ring is configured to present the fork from disengaging with the coupling.

11. The skewer according to claim 3, wherein the second portion comprises:
an inner surface and an outer surface spaced apart from one another;
an aperture defined by the inner surface; and
wherein the shaft of the motor is received within the aperture.

12. The skewer according to claim 11, wherein the second portion further comprises:
a hole extending radially from the inner surface to the outer surface; and
wherein a securement device is at least partially received within the hole to hold and secure the shaft of the motor within the aperture.

13. A method of using a skewer, comprising:
selectively engaging a fork with a housing of the skewer;
receiving a food product on the fork;
placing the food product at least partially over a heat source; and
rotating the fork via a motor assembly without moving a user's hand.

14. The method according to claim 13, further comprising:
engaging a button; and
activating a motor assembly to rotate the fork.

15. The method according to claim 13, further comprising:
engaging the fork with the motor assembly and thereby securing the fork to the housing.

16. The method according to claim 15, wherein engaging the fork to the motor assembly further comprises:
receiving at least a portion of the fork within a coupling.

17. The method according to claim 16, further comprising:
inserting a rod of the fork into a projection and a first portion of the coupling;
engaging a set of bumps extending radially outwardly from a rod of the fork with a projection of the coupling;
inserting the set of bumps into a pair of slots defined by the projection; and
enlarging a split ring received around the projection.

18. The method according to claim 17, further comprising:
continuing to insert the rod into the first portion of the coupling;
inserting the set of bumps into a pair of insets defined by the first portion; and
receiving at least a portion of the rod within a passage defined by the first portion.

19. The method according to claim 15, wherein powering the motor of the motor assembly further comprises:
engaging a control to transmit a signal to a circuit board; and
drawing power by the circuit board from a battery.

20. The method according to claim 19, wherein the battery is replaceable by:
removing a cover;
removing a spent battery from a battery holder;
inserting a new battery into the battery holder; and
replacing the cover.
